(19) United States
(12) Patent Application Publication
(10) Pub. No.: US 2021/0364129 A1
(43) Pub. Date: Nov. 25, 2021

(54) DEVICE AND METHOD FOR TRANSFERRING CRYOGENIC FLUID

(71) Applicant: L'Air Liquide, Societe Anonyme pour l'Etude et l'Exploitation des Procedes Georges Claude, Paris (FR)

(72) Inventors: Laurent ALLIDIERES, Paris (FR); Thomas FAYER, Sassenage (FR); Cyril BENISTAND-HECTOR, Sassenage (FR)

(73) Assignee: L'Air Liquide, Societe Anonyme pour l'Etude et l'Exploitation des Procedes Georges Claude, Paris (FR)

(21) Appl. No.: 17/322,441

(22) Filed: May 17, 2021

(30) Foreign Application Priority Data
May 20, 2020 (FR) FR 2005144

(51) Int. Cl. F17C 5/02

(52) U.S. Cl. CPC F17C 5/02; F17C 2223/0161; F17C 2221/012; F17C 2205/0352; F17C 2205/0323; F17C 2227/0135

(57) ABSTRACT

Method and device for transferring cryogenic fluid comprising a first tank for distributing cryogenic fluid, a second, receiving cryogenic tank accommodating a cryogenic fluid, a fluid transfer circuit connecting the first and the second tank, the transfer circuit comprising a first pipe that connects the upper parts of the first and second tanks and comprises at least one valve, the transfer circuit comprising a second pipe that connects the lower part of the first tank to the second tank, the second transfer pipe comprising a pump that comprises an inlet connected to the first tank and an outlet connected to the second tank and the pump and the at least one valve of the first pipe being configured to place the upper parts of the first and second tanks in fluidic communication by opening the at least one valve during a transfer of liquid from the first tank to the second tank by way of the pump.

### CROSS-REFERENCE TO RELATED APPLICATIONS

This application claims the benefit of priority under 35 U.S.C. § 119 (a) and (b) to French patent application No. FR 2 005 144, filed May 20, 2020, the entire contents of which are incorporated herein by reference.

### BACKGROUND

### Field of the Invention

The invention relates to a device and a method for transferring cryogenic fluid in a liquefied gas storage vessel.

The invention relates more particularly to a device for transferring cryogenic fluid comprising a first tank for distributing cryogenic fluid, said first tank storing a cryogenic fluid with a lower liquid phase and an upper gas phase, a second, receiving cryogenic tank accommodating a cryogenic fluid comprising a lower liquid phase and an upper gas phase, a fluid transfer circuit connecting the first and the second tank, the transfer circuit comprising a first pipe that connects the upper parts of the first and second tanks and comprises at least one valve, the transfer circuit comprising a second pipe that connects the lower part of the first tank to the second tank.

### Related Art

In order to fill a liquid hydrogen tank from a mobile tank (semitrailer), a system for delivering liquid by means of a difference in pressure is generally used. Typically, the storage vessel to be filled is at a pressure of between 1.0 and 13 bara (typically 3 bara) and the liquid contained in the delivery tank is at a pressure of between 1.0 bara and 13 bara. In order to achieve this transfer by means of a pressure differential, in most cases it is necessary first of all to pressurize the tank of the delivery semitrailer to a pressure typically higher by 1 barg than the pressure in the fixed storage vessel that is to be filled.

Currently, an atmospheric heater is generally placed beneath the delivery semitrailer so as to allow the pressurization and the transfer of its contents to a receiving tank.

This system has several disadvantages. Thus, it is difficult to control the performance since this is related to the weather conditions (temperature, wind, humidity). In addition, the stratification brought about in the gas headspace of the delivery semitrailer (increase in the temperature of the gas with altitude) will tend to heat the liquid hydrogen delivered to the customer (all the more so in the event of multiple deliveries). Thus, the hydrogen delivered is of lower quality. In addition, the need to pressurize the tank of the delivery semitrailer before starting the transfer can last from 15 min to 60 min depending on the level in the delivery tank.

Other known solutions use a pump to transfer liquid from one storage vessel to the other. However, the use of a pump makes it necessary to provide an atmospheric heater in order to compensate for the exiting liquid volume with gas coming from the heater.

In addition, current transfer pump technologies have other drawbacks. Thus, by pumping liquid, the pump adds heat to the fluid to be transferred, and can suffer damage by cavitation within the cryogenic liquid with a decrease in the pumped flow rate. Furthermore, the pump provides a significant flow rate entering the customer tank. As a result, a significant amount of gas has to be vented in order to leave space for this entering liquid volume.

### SUMMARY OF THE INVENTION

An aim of the present invention is to remedy all or some of the drawbacks of the prior art that are set out above.

To this end, the device according to the invention, which is otherwise in accordance with the generic definition thereof given in the above preamble, is essentially characterized in that the second transfer pipe comprises a pump that comprises an inlet connected to the first tank and an outlet connected to the second tank and in that the pump and the at least one valve of the first pipe are configured to place the upper parts of the first and second tanks in fluidic communication by opening the at least one valve during a transfer of liquid from the first tank to the second tank by way of the pump.

Furthermore, embodiments of the invention may have one or more of the following features:
the second pipe comprises an end connecting the lower part of the first tank to the lower part of the second tank,
the second pipe comprises an end connecting the lower part of the first tank to the upper part of the second tank,
the second tank comprises a system for pressurizing the tank, comprising a pipe that connects the lower part and upper part of the tank and is provided with a heater and a set of one or more valves.

The invention also relates to a method for transferring cryogenic fluid between a first tank for distributing cryogenic fluid and a second cryogenic tank of a device in accordance with any one of the features above or below, the method comprising a step of transferring liquid from the first tank to the second tank by way of the pump and, simultaneously, placing the upper parts of the first and second tanks in fluidic communication by opening the at least one valve of the first pipe.

According to other possible particular features:
during the step of transferring liquid from the first tank to the second tank by way of the pump, the liquid is transferred into the lower liquid part and/or into the upper gas part of the second tank,
the method involves, prior to the step of transferring liquid, a step of pressure equalizing between the two cryogenic tanks during which only the upper parts of the first and second tanks are placed in fluidic communication by opening the at least one valve of the first pipe,
the step of pressure equalizing is maintained until the difference in pressure between the two tanks reaches a determined threshold, for example of between zero and one bar,
the method comprises, at the same time as the step of transferring liquid from the first tank to the second tank by way of the pump, a step of pressurizing the second tank and/or the first tank,
the pressurizing step is carried out by a system for pressurizing the second tank or the first tank, comprising a pipe that connects the lower part and upper part of said tank and is provided with a set of one or more valves and a heater.

The invention can also relate to any alternative device or method comprising any combination of the features above or below within the scope of the claims.

### BRIEF DESCRIPTION OF THE FIGURES

Further particular features and advantages will become apparent upon reading the following description, which is provided with reference to the figures, in which:

FIG. 1 shows a schematic and partial view illustrating the structure and operation of an example of a device according to the invention in a first possible use step,

FIG. 2 shows the same device in another operating configuration,

FIG. 3 shows the same device in another operating configuration,

FIG. 4 represents a schematic and partial view illustrating the structure and operation of another possible example of a device according to the invention.

### DETAILED DESCRIPTION OF THE INVENTION

The device 1 for transferring cryogenic fluid comprises a first tank 2 for distributing cryogenic fluid, for example a mobile tank 2 mounted on a semitrailer.

Conventionally, the first tank 2 stores a cryogenic fluid, for example hydrogen, with a liquid phase in the lower part and a gas phase in the upper part.

The device 1 comprises a second cryogenic tank 3 for receiving the same fluid, which tank is for example fixed, accommodating or intended to accommodate a cryogenic fluid with a liquid phase in the lower part and a gas phase in the upper part. The device 1 comprises a fluid transfer circuit that is able to connect the first 2 and the second 3 tank. This transfer circuit comprises a first pipe 4 having two ends that are connected to the upper parts of the first 2 and second 3 tanks, respectively. This first pipe 4 comprising at least one valve 5 (and for example preferably at least two valves in series), and of which one end is connected to the second tank 3, comprises detachable connection members so as to allow successive connections to various tanks that are to be supplied with fluid.

The transfer circuit comprises a second pipe 6 that is able to connect the lower part of the first tank 2 to the second tank 3 (in the upper and/or lower part). In the example shown, the second pipe 6 comprises two downstream ends that are connected to the lower part and upper part of the second tank 3, respectively. The second transfer pipe 6 comprises a pump 7 comprising an inlet connected to the first tank 2 and an outlet connected to the second tank 3. This second pipe 6 preferably comprises a set of one or more valves for interrupting or authorizing the transfer of liquid stream from the first tank 2 to the second tank 3. As above, at least at its one or more downstream ends connected to the second tank 3, the second pipe 6 comprises detachable connection members so as to allow successive connections to various tanks that are to be supplied.

As described in greater detail below, the pump 7 and the set of one or more valves 5 of the first pipe 4 are configured to place the upper parts (gas phases) of the first 2 and second 3 tanks in fluidic communication during a transfer of liquid from the first tank 2 to the second tank 3 by way of the pump 7.

Placing the gas headspaces of the two tanks 2, 3 in communication during pumping improves the thermal and hydraulic efficiency of the transfer of fluid in an optimized sequential procedure. This makes the use of an atmospheric heater on the first tank 2 optional, and allows the gas headspace of the second tank 3 to be put to profitable use while at the same time improving the quality of the molecule delivered and the volumetric efficiencies of the deliveries.

Thus, while the pump 7 circulates liquid from the first tank 2 to the second tank 3, the second pipe 6 allows the “surplus” gas present in the second tank 3 to circulate by means of a pressure differential into the first tank 2, in particular so as to fill the volume left free by the withdrawal of liquid.

A use example will be described below.

In the case of a delivery of liquefied gas, such as hydrogen for example, the first tank 2 can arrive at the site of the second tank 3. The first tank 2 has, for example, an internal pressure of between 1 and 6 bara. The operator can connect the two tanks 2, 3 using the first 4 and second 6 pipes. Upon this connection, the sets of valves are closed.

Preferably, operations of inerting and/or flushing and/or cooling the pipes 4, 6 are then carried out.

The one or more valves 5 of the first pipe 4 are opened. The pressure is equalized between the two tanks 2, 3 (cf. FIG. 1).

Preferably, when the difference in pressure between the two tanks 2, 3 is reduced to close to 0 bar (or to a determined value below 1 bar, for example), the pump 7 can then be started.

This makes it possible to take advantage of the pressure in the second tank 3 in order to increase the pressure at the intake of the pump and optimize the NPSH (inlet pressure drop) of the pump 7.

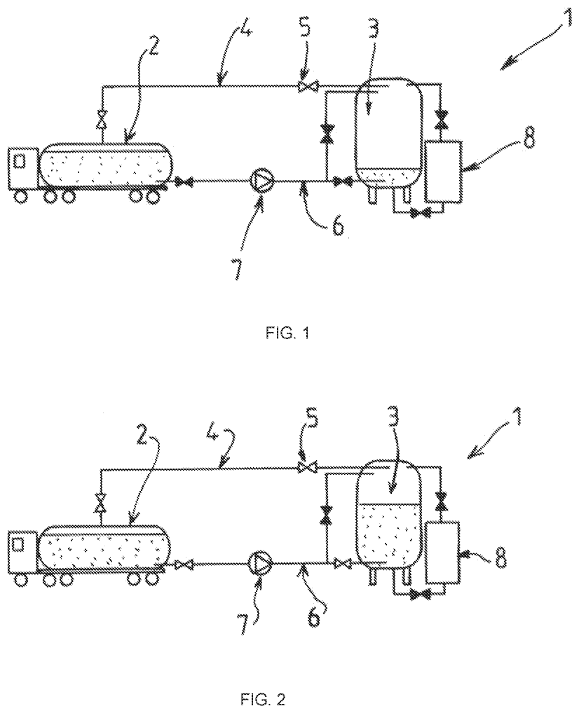

The point at which the pressure is equalized between the two tanks 2, 3 can be at an intermediate pressure between the two initial pressures in the two tanks 2, 3, typically of between 2 and 8 bar. This equalizing pressure depends in particular on the initial pressure in the two tanks 2, 3, on their liquid level and on their respective volumes. The first tank 2 will generally have a pressure that is slightly lower than the pressure in the second tank 3. The pump can then be started and the corresponding valves opened so as to transfer liquid (cf. FIG. 2).

The pump 7 is preferably configured to compensate for the pressure drops in the liquid line (second pipe 6) and the gas line (first pipe 4). In particular, the first pipe 4 can be thermally insulated in order to reduce the pressure drops.

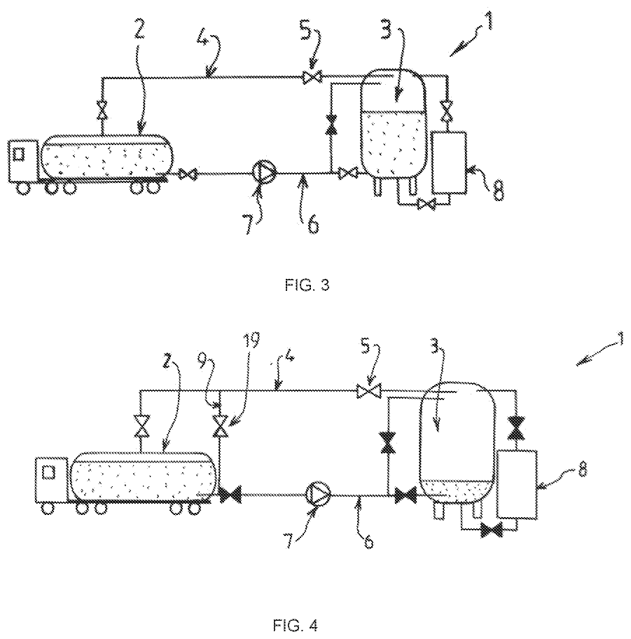

If the NPSH of the pump 7 becomes insufficient during the transfer, it is possible to optionally use an atmospheric heater situated for example at the site of the second tank 3 cf. [FIG. 3] (or on the first tank 2 or both simultaneously) so as to pressurize the gas headspaces of the two tanks 2, 3 that are connected by fluidic communication.

For example, the second tank 3 comprises a pressurization system 8 comprising a pipe that connects the lower part and upper part of said tank and is provided with a set of one or more valves and an atmospheric heater (heating heat exchanger).

The pump 7 is preferably a pump of the single- or multi-stage centrifugal type, with a specific speed chosen so as to increase the isentropic efficiency for a relatively small difference in pressure. It can be installed on the first tank 2 or at the site of the second tank 3, preferably in a thermally insulated container or integrated directly in the internal structure of a thermally insulated tank 2, 3. Its electrical power is preferably lower than 10 kW.

For example, the pump 7 can be a pump of the type that is partially submerged in the pumped cryogenic liquid in a cold box (the motor of the pump being out of the cold box) or a pump of the type that is totally insulated in a cold box (vacuum insulated). For example, the pump 7 can be submerged in a fluid reserve (sump), i.e. in a relatively small dedicated intermediate liquid tank (of the cryostat type, for so example). Likewise, the pump 7 could be (at least partially) directly submerged in one of the two tanks 2, 3 mentioned above (in this case the pump is at least partially integrated in a tank). Any other arrangement of one or more pumps can be envisaged.

Thus, although it is inexpensive and simple in structure, the invention offers numerous advantages.

Thus, the introduction of heat into the system is minimized since the evaporated gas from the second tank 3 is used in addition to the transfer pump 7. The pump 7 provides only a small pressure differential (a few bar). The vaporization (boil-off) loss is therefore minimal in the logistics chain. The gas headspace of the second tank 3 is put to profitable use. This gas is not vented.

In addition, the quality of the molecule delivered is improved (lower delivery temperature). Multiple deliveries with a single mobile tank 2 are more efficient. The solution does not require consumption of liquid for pressurization. Furthermore, the immobilization time is reduced since the pressurization time is reduced.

The solution allows a possible increase in the transfer flow rate while at the same time maintaining relatively stable pumping conditions. In addition, the transfer flow rates are independent of the weather conditions. The solution substantially reduces or eliminates the cryogenic cloud and the condensation of liquid oxygen under the mobile delivery tanks 2.

In addition, the procedures for the delivery operators are simplified.

The two tanks 2, 3 operate at relatively lower pressure, and this potentially makes it possible to reduce the mechanical size constraints (saving in terms of weight, material, cooling time and cost).

It is thus no longer necessary to equip the first tank 2 with an atmospheric heater, or the dimensions of the latter can be greatly reduced.

The electrical consumption of the liquid transfer pump 7 is markedly lower than that of a gas compressor that could be used on the pipe 4 connecting the two gas headspaces, especially since the conditions of the method (temperature in particular) at the inlet of the compressor are much more variable than at the inlet of the pump.

In the embodiment shown in FIG. 4, the device 1 comprises a third pipe 9 connecting the first pipe 4 to the lower part of the first tank 2. This third pipe 9 may be part of the transfer circuit and/or may belong to the first tank 2.

As illustrated, this third pipe 9 is preferably provided with a valve 19 such as an isolation valve allowing, in an open position, to depressurize the gaseous sky of the second tank 3 into the liquid phase of the first tank 2. That is to say, this third pipe 9 can allow vapors from the second tank 3 (via the first line 4) to be recovered into the liquid phase of the first tank 2 (and condense them).

After such pressure balancing, liquid can be drawn from the first tank 2 via the second line 6 (and the pump 7).

This may lead to heating of the liquid phase in the first tank 2, but in some applications this may be expected and advantageous (e.g. at a pressure of 5 bar).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A method for transferring cryogenic fluid using a device for transferring cryogenic fluid that comprises a first tank for distributing a cryogenic fluid and storing a cryogenic fluid in liquid phase in a lower part therein and in gaseous phase in an upper part therein at an initial pressure, a second cryogenic tank that accommodates the cryogenic fluid from the first tank in liquid phase in a lower part therein and in gaseous phase in an upper part therein at an initial pressure, and a fluid transfer circuit connecting the first and the second tank, the transfer circuit comprising a first pipe that connects the upper parts of the first and second tanks and which comprises at least one valve and a second pipe that connects the lower part of the first tank to the second tank and which comprises a set of one or more valves for interrupting or authorizing a transfer of a liquid stream of the cryogenic fluid from the first tank to the second tank 3, and also a pump that comprises an inlet connected to the first tank and an outlet connected to the second tank, the pump and the at least one valve of the first pipe being configured to place the upper parts of the first and second tanks in fluidic communication by opening the at least one valve during a transfer of liquid from the first tank to the second tank by way of the pump, the method ensuring a transfer of cryogenic fluid between the first tank and the second cryogenic tank, the method comprising the steps of:
with the at least one valve of the first pipe being closed at the set of valves of the second pipe being initially closed, opening the at least one valve of the first pipe 4 are opened, thereby pressure equalizing the first and second tanks and lowering the pressure of the second tank from the initial pressure thereof and increasing the pressure of the first tank from the initial pressure thereof; and
starting the pump and opening the set of valves of the second pipe, thereby transferring the cryogenic fluid in liquid form from the first tank to the second tank.

14. The method of claim 13, wherein said step of starting the pump commences when the lowered pressure of the second tank and the increased pressure of the first tank are between 2 and 8 bar, the lowered pressure being higher than the increased pressure.

15. The method of claim 14, wherein a difference between the increased pressure and the decreased pressure is a determined difference of less than 1 bar.

16. The method of claim 13, further comprising a step of pressurizing the first tank or the second tank using an atmospheric heater when a NPSH of the pump becomes insufficient for the transfer of cryogenic fluid from the first tank to the second tank.

17. The method of claim 13, wherein the second pipe connects the lower part of the first tank to the lower part of the second tank.

18. The method of claim 13, wherein the second pipe connecting the lower part of the first tank to the upper part of the second tank.

19. The method of claim 13, wherein the cryogenic fluid is hydrogen.

20. A cryogenic fluid transfer device comprising a first cryogenic fluid distribution tank storing a cryogenic fluid in liquid phase in a lower part thereof and in gaseous phase in an upper part thereof, a second cryogenic receiving tank housing a cryogenic fluid in liquid phase in a lower part thereof and in gaseous phase in an upper part thereof, and a fluid transfer circuit connecting the first and second tanks, the transfer circuit comprising a first pipe connecting the upper parts of the first and second tanks and comprising at least one valve, and a second pipe connecting the lower part of the first tank to the second tank that comprises a pump that has an inlet connected to the first tank and an outlet connected to the second tank, wherein:
the pump and the at least one valve of the first line are configured so as to ensure a fluidic connection of the upper parts of the first and second tanks by opening the at least one valve during a transfer of the cryogenic fluid in liquid phase from the first tank to the second tank with the pump.

21. The cryogenic fluid transfer device of claim 20, further comprising a third pipe that connects the upper part of the second tank to the lower part of the first tank, the third pipe comprising a valve.
